(19) United States
(12) Patent Application Publication
(10) Pub. No.: US 2025/0383015 A1
(43) Pub. Date: Dec. 18, 2025

(54) SPLIT RIM ASSEMBLY PULLEY AND MANUFACTURING METHOD THEREOF

(71) Applicant: Yoon Kon KIM, Ansan-si, Gyeonggi-do (KR)

(72) Inventor: Yoon Kon KIM, Ansan-si, Gyeonggi-do (KR)

(21) Appl. No.: 18/877,334

(22) PCT Filed: Jul. 1, 2022
(86) PCT No.: PCT/KR2022/009536

§ 371 Date: Dec. 20, 2024

(51) Int. Cl. F16H 55/46; F16H 55/49

(52) U.S. Cl. CPC F16H 55/46; F16H 55/49

(57) ABSTRACT

The present invention relates to a split rim assembly pulley and a manufacturing method thereof, the split rim assembly pulley comprising: a hub coupled to a shaft; a plurality of arms arranged radially around the hub; a plurality of split rims arranged in a circle to form a plurality of unit rings that are stacked on each other and coupled to the other end of each of the arms to form a rim that is concentrically fixed to the hub; and a plurality of fastening members fastened to the plurality of split rims so as to maintain the state in which the split rims form the rim.

### TECHNICAL FIELD

The present invention relates to a pulley and a method of manufacturing the same, and more particularly, to a split rim-type assembly pulley that may be manufactured to have various specifications by assembly through press processing instead of performing a casting process or a forging process, and a method of manufacturing the same.

### BACKGROUND ART

Generally, a V-belt pulley is used to convert a speed of a motor in an environment in which the motor is used and transmit the converted speed to an actuator. Thus, depending on power to be transmitted and characteristics of a mechanical device, the type and the number of a belt may be changed, and the type, an outer diameter, or the like of a pulley may be changed.

The basic operation principle of the V-belt pulley is that a V belt receives power of the motor to rotate or move the actuator and is used in various forms in various industries and workplace environments, the V belt being configured such that two pulleys spaced a certain distance from each other are provided, a driving pulley on one side thereof is driven by the motor, and a driven pulley on the other side thereof is connected to the driving pulley.

The V-belt pulley uses a V-belt having a “V” shape, generates a wedge action when coming into contact with the V-belt, and obtains a greater contact force than a flat belt pulley, and thus the V-belt doesn't come off easily.

However, since a pulley according to the related art is mainly manufactured through methods such as casting, when a large pulley is required, it is difficult to manufacture the pulley. Further, when a pulley is manufactured by a casting manner, a poor casting environment and poor casting work cause environmental pollution, and pulley manufacturing methods which are not environment-friendly method become unsuitable in consideration of the trend of changing environmental awareness.

### DESCRIPTION OF THE INVENTION

### Technical Problem

To solve the problems of the related art, the present invention is directed to providing a split rim-type assembly pulley which may be manufactured in the form of assembly through press processing instead of performing a casting process or a forging process and thus easily manufactured in various specifications and forms, and in which, in particular, a large pulley may be easily manufactured, and as compared to a casting method according to the related art in which environmental pollution is severe, the split rim-type assembly pulley may be manufactured to be eco-friendly and contribute to work efficiency and health of a worker by improving a work environment.

### Technical Solution

To solve the above problems, one aspect of the present invention provides a split rim-type assembly pulley including a hub coupled to a shaft, a plurality of arms each having one end coupled to the hub and radially arranged around the hub, a plurality of split rims which are members having an arc shape and are arranged in a circular shape to form a unit rim, in which the plurality of unit rims are stacked in the split rims, and which are coupled to the other ends of the arms to form a rim fixed to form concentricity in the hub, and a plurality of fastening members fastened to the plurality of split rims to maintain a state in which the split rims constitute the rim.

In the hub, an arm coupling portion may protrude along an outer circumferential surface thereof for bolting fastening with the arm, and a plurality of fastening holes may be spaced apart from each other in the arm coupling portion.

In the hub, the plurality of arm coupling portions may be provided side by side, so that the plurality of arms may be coupled to be arranged in a longitudinal direction of the shaft.

In the arm, a reinforcement wing portion may be provided by bending one side or both sides thereof.

In the arm, a reinforcement wing portion may be provided by bending one side or both sides thereof, and when the plurality of arms are arranged, the reinforcement wing portions may be arranged to face each other.

When the split rim forms the unit rim, a bent portion may be formed by bending an outer circumferential surface of the unit rim by press processing, and when the unit rim is stacked to be symmetrical in a left-right direction to form the rim, a groove which is open to the outside and on which a V-belt is seated may be provided between the bent portions.

The split rim-type assembly pulley may further include a first spacer that allows a fastening bolt of the fastening member to pass therethrough such that the first spacer is located between the split rims located on both sides of the groove, to maintain a width of the groove in correspondence with specifications of the V-belt and a second spacer that allows a fastening bolt of the fastening member to pass therethrough such that the second spacer is located between the split rims located between the pair of grooves to be disposed alternately with the first spacer on the fastening bolt.

The split rim may maintain a state in which the rim is formed by the fastening member in a state in which boundary portions with other split rims are arranged not to be aligned from each other in each of the neighboring unit rims.

The fastening member may include a fastening bolt which passes through the plurality of stacked split rims and of which an end protrudes and a fastening nut fastened to the end of the fastening bolt to prevent separation of the stacked split rims.

The arm may be fixed to the split rim by the fastening member as the fastening bolt passes through the other end of the arm.

The split rim-type assembly pulley may further include a third spacer stacked and inserted together with the other end of the arm between the split rims located on both sides of a groove, on which a V-belt is seated, such that the fastening bolt passes therethrough, to maintain a width of the groove in correspondence to specifications of the V-belt.

Another aspect of the present invention provides a method of manufacturing a split rim-type assembly pulley, wherein a plurality of split rims which are members having an arc shape are arranged in a circular shape to form a unit rim, a shape of a rim formed by stacking the plurality of unit rims is maintained by fastening a fastening member, an end of each of a plurality of arms radially coupled around a hub is coupled to the rim, so that the rim is concentrically fixed to the hub.

The end of each of the arms may be fixed to the rim by the fastening member fastened to maintain the shape of the rim.

### Advantageous Effects

According to a split rim-type assembly pulley and a method of manufacturing the same according to the present invention, the split rim-type assembly pulley may be manufactured in the form of assembly through press processing instead of performing a casting process or a forging process and thus the split rim-type assembly pulley is easily manufactured in various specifications and forms, in particular, a large pulley may be easily manufactured due to a split structure of a rim, and as compared to a casting method according to the related art in which environmental pollution is severe, the split rim-type assembly pulley may be manufactured to be eco-friendly and contribute to work efficiency and health of a worker by improving a work environment.

### DESCRIPTION OF DRAWINGS

FIG. 1 is a perspective view illustrating a split rim-type assembly pulley according to an embodiment of the present invention.

FIG. 2 is a side view illustrating the split rim-type assembly pulley according to the embodiment of the present invention.

FIG. 3 is a partial exploded view illustrating the split rim-type assembly pulley according to the embodiment of the present invention.

FIG. 4 is a cross-sectional view along line A-A of FIG. 2.

FIG. 5 is a cross-sectional view along line B-B of FIG. 2.

FIG. 6 is a perspective view illustrating a hub of the split rim-type assembly pulley according to the embodiment of the present invention.

FIG. 7 is a perspective view illustrating a unit rim by arrangement of a divided rim of the split rim-type assembly pulley according to the embodiment of the present invention.

### MODES OF THE INVENTION

Since the present invention may have various embodiments due to various changes, specific embodiments will be illustrated and described in the drawings as examples. Further, the present invention is not limited to these specific embodiments and should be understood to include all changes, equivalents, or substitutes included in the technical spirit of the present invention.

Hereinafter, embodiments according to the present invention will be described in detail with reference to the accompanying drawings, and the same reference numerals are assigned to the same or corresponding components regardless of the drawing numerals, and duplicated descriptions thereof will be omitted.

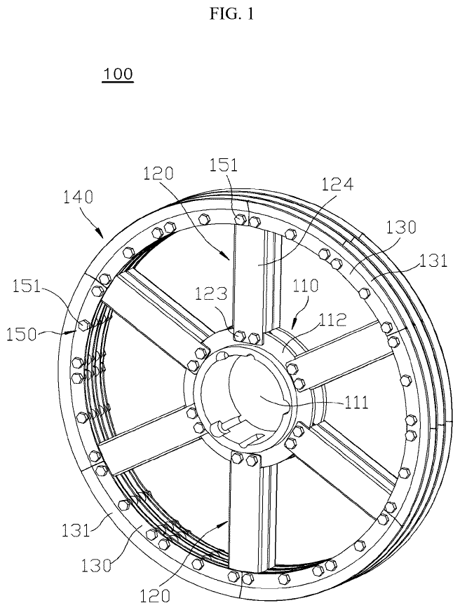

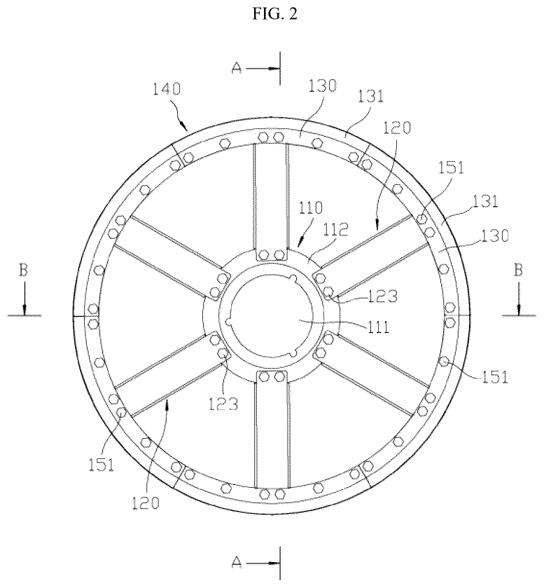

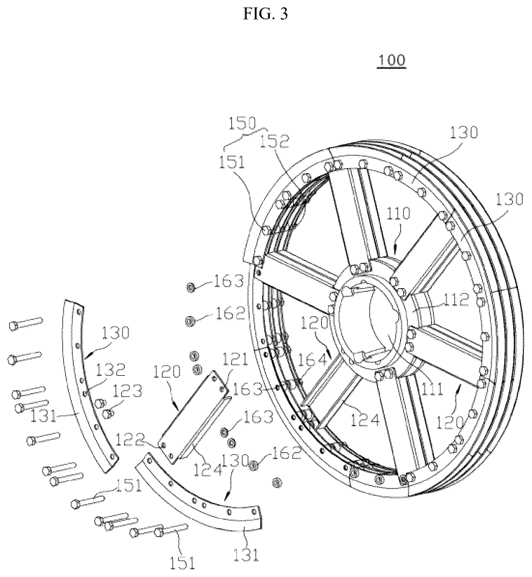

FIG. 1 is a perspective view illustrating a split rim-type assembly pulley according to an embodiment of the present invention, FIG. 2 is a side view illustrating the split rim-type assembly pulley according to the embodiment of the present invention, and FIG. 3 is a partial exploded view illustrating the split rim-type assembly pulley according to the embodiment of the present invention.

Referring to FIGS. 1 to 3, a split rim-type assembly pulley 100 according to an embodiment of the present invention may include a hub 110, an arm 120, a split rim 130, and a fastening member 150. Further, the split rim-type assembly pulley 100 according to the embodiment of the present invention may be made of steel, but the present invention is not necessarily limited thereto, the split rim-type assembly pulley 100 may be made of various metals or alloys of metals, including steel use stainless (SUS) or stainless steel (SS), and components may be made of dissimilar materials as needed.

The hub 110 is coupled to a shaft to receive a rotational force by a motor or the like or receive a rotational force by a V-belt, and a shaft coupling part 111 for coupling the shaft is provided in a center of the hub 110. The shaft is directly fixed to the shaft coupling part 111 of the hub 110 or a tapered bush is detachably mounted on the shaft coupling part 111, and thus, the coupling with the shaft may be easily mediated. The tapered bush may be formed integrally with the hub 110.

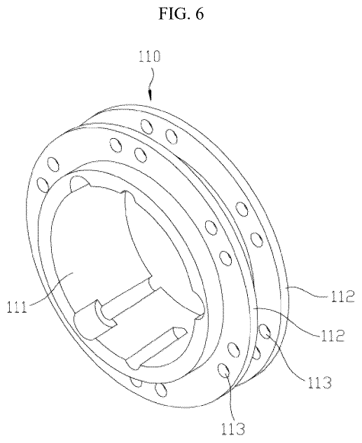

Referring to FIGS. 3 and 6, in the hub 110, an arm coupling portion 112 may protrude along an outer circumferential surface thereof for bolting fastening with the arm 120, which will be described below, a plurality of fastening holes 113 may be provided in the arm coupling portion 112 to be spaced apart from each other, the arm coupling portion 112 may be provided as a plurality of arm coupling portions 112 that are arranged in parallel, and thus the arm 120 may be provided as a plurality of arms 120 that are arranged and coupled in a longitudinal direction of the shaft.

Referring to FIGS. 1 to 3, one end of each of the arms 120 is coupled to the hub 110, and thus the plurality of arms 120 are radially arranged around the hub 110. The arm 120 may be manufactured by press processing or the like, a fixing member 123, e.g., a bolt, passing through a first fixing hole 121 formed at the one end of the arm 120 may be fastened to a fastening hole 113 of the arm coupling portion 112, and thus the one end of the arm 120 may be fixed to the hub 110. Further, a second fixing hole 122 may be formed at the other end of the arm 120 so that a fastening bolt 151 of the fastening member 150, which will be described below, or a separate bolt is inserted thereinto.

The arm 120 may be provided with a reinforcement wing portion 124 by bending one side or both sides thereof. Thus, the arm 120 may increase durability of the hub 110 and a rim connection structure may be increased due to the arm 120 by increasing bending strength or the like by the reinforcement wing portion 124. Further, when the plurality of arms 120 are arranged, the reinforcement wing portions 124 may be arranged to face each other. Therefore, an excellent aesthetic appearance may be provided, cause of interference with other members is functionally minimized, and thus reliability of a rotational motion may be increased.

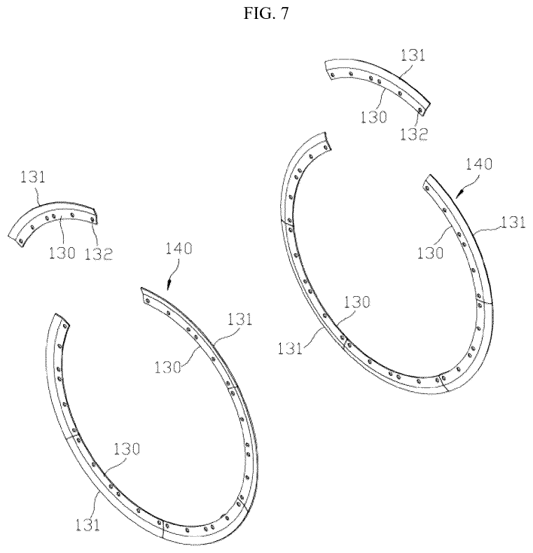

Referring to FIGS. 1 to 3 and 7, a plurality of split rims 130 are members having an arc shape and are arranged in a circular shape to form the unit rim 140, and thus, the plurality of unit rims 140 are stacked and coupled to both ends of the arms 120 to form a rim fixed to form concentricity in the hub 110. The split rim 130 may have a plate-like structure and thus be maintained in a stable stacking state, and a plurality of third fixing holes 132 may be formed in a longitudinal direction such that the fastening bolt 151 of the fastening member 150, which will be described below, passes therethrough.

When the split rim 130 forms the unit rim 140, a bent portion 131 may be formed by bending an outer circumferential surface of the unit rim 140 by press processing, and when the unit rim 140 is stacked to be symmetrical in a left-right direction to form a rim, a groove 161 which is open to the outside and on which the V-belt is seated may be provided between the bent portions 131 outside.

First and second spacers 162 and 164 may be additionally installed between the split rims 130 to maintain a width of the groove 161 and maintain a stable stacking state. The first spacer 162 allows the fastening bolt 151 of the fastening member 150, which will be described below, to pass therethrough such that the first spacer 162 is located between the split rims 130 located on both sides of the groove 161, to maintain the width of the groove 161 in correspondence to specifications of the V-belt, and thus the first spacer 162 may be fixed between the split rims 130. The second spacer 164 allows the fastening bolt 151 of the fastening member 150 to pass therethrough such that the second spacer 164 is located between the pair of split rims 130 located between the pair of grooves 161, and thus the second spacer 164 is disposed alternately with the first spacer 162 on the fastening bolt 151.

The split rim 130 may maintain a state in which the rim is formed by the fastening member 150 in a state in which boundary portions with other split rims 130 are arranged not to be aligned from each other in each of the neighboring unit rims 140. For example, the split rim 130 may be disposed in a zigzag in the stacking direction of the unit rim 140, and accordingly, the split rims 130 may be stacked to the single split rim 130 in a state in which the plurality of split rims 130 are connected. Thus, boundary portions between the split rims 130 constituting the unit rim 140 may not be aligned from each other in each of the neighboring unit rims 140, and thus the split rim 130 may serve to connect the split rims 130 constituting other neighboring unit rims 140 to each other. This connection structure between the split rims 130 is particularly useful when all of the split rims 130 have the same specifications. However, the specifications of the split rim 130, such as a length, are changed, and thus the split rim 130 may also serve to connect the split rims 130 constituting the other neighboring unit rims 140 to each other by the fastening member 150.

The unit rim 140 formed by arranging the plurality of split rims 130 may be formed in the number of pairs corresponding to the number of connected V-belts for configuration of the rim. Further, the number of split rims 130 may be six in the present embodiment or three or various numbers as another example in each of the unit rims 140. When the number of split rims 130 is six in the present embodiment, each of the split rims 130 is separated by the one unit rim 140 by 60 degrees, and when the number of split rims 130 are three, each of the split rims 130 divides the one unit rim 140 by 120 degrees. Further, when the number of unit rims 140 is six, adjacent one unit rim 140 may be more rotated and arranged by 30 degrees than the unit rim 140, and adjacent another unit rim 140 may be more rotated and arranged by 30 degrees than the one unit rim 140 such that connection parts of the split rims 130 are not aligned from each other. A rotational angle herein is an example and may be changed. In this way, the rotational angle may be also determined differently according to the number of split rims 130 constituting the unit rim 140.

A plurality of fastening members 150 are fastened to the plurality of split rims 130 to maintain a state in which the split rims 130 constitute the rim. The fastening member 150 may include, for example, the fastening bolt 151 of which an end protrudes while passing through the plurality of stacked split rims 130 and a fastening nut 152 fastened to the end of the fastening bolt 151 to prevent separation of the stacked split rims 130.

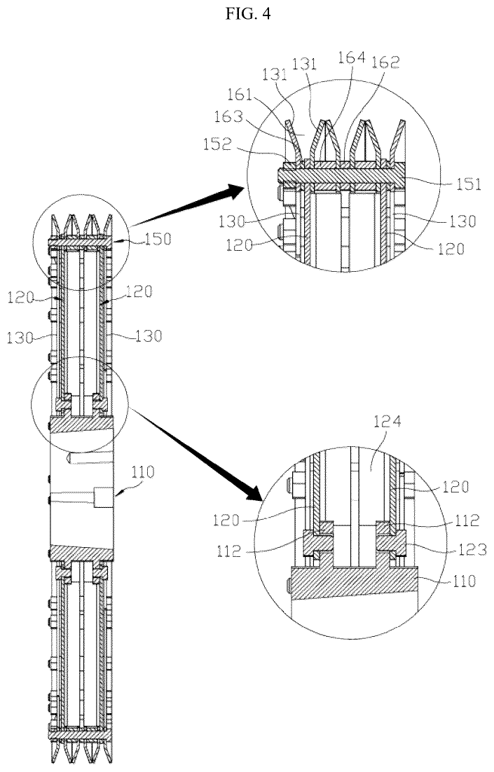

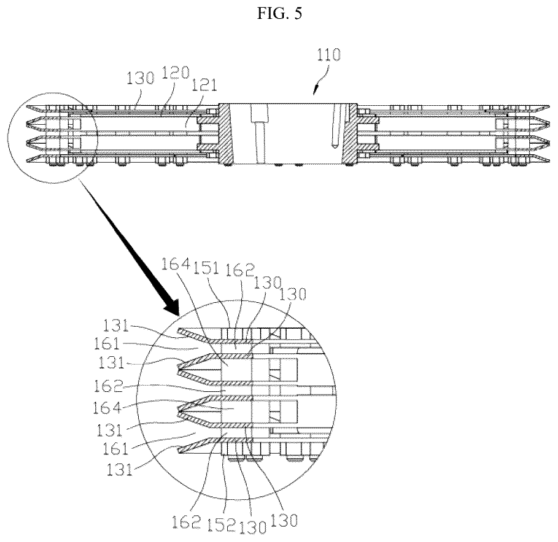

Referring to FIGS. 3 to 5, the other end of the arm 120 may be fixed to the unit rim 140 by a separate bolt, but the present invention is not limited thereto, and in the present embodiment, the fastening bolt 151 may pass through the other end and thus be fixed to the split rim 130 by the fastening member 150. In this case, together with the other end of the arm 120 between the split rims 130 located on both sides of the groove 161 on which the V-belt is seated, the third spacer 163 is stacked and inserted such that the fastening bolt 151 passes therethrough, and thus, the width of the groove 161 may be maintained in correspondence to the specifications of the V-belt.

A method of manufacturing a split rim-type assembly pulley according to another embodiment of the present invention is a method of manufacturing the split rim-type assembly pulley 100 according to the embodiment of the present invention. The plurality of split rims 130 including members having an arc shape are arranged in a circular shape to form the unit rim 140, the shape of the rim formed by stacking the plurality of unit rims 140 is maintained by fastening the fastening member 150, the end of each of the plurality of arms 120 radially coupled around the hub 110 is coupled to the rim, and thus the rim is concentrically fixed to the hub 110. Here, the end of each of the arms 120 may be fixed to the rim by the fastening member 150 fastened to maintain the shape of the rim.

Meanwhile, the unit rims 140 may be coupled to each other by welding, perpendicularity of the welded result may be corrected and concentricity may be checked through leveling after the welding, and finishing work may also be performed on parts that are not corrected using computerized numerical control (CNC) lathe work.

According to the split rim-type assembly pulley and the method of manufacturing the same according to the present invention, the split rim-type assembly pulley may be manufactured in the form of assembly through press processing instead of performing a casting process or a forging process and thus easily manufactured in various specifications and forms, and in particular, a large pulley may be easily manufactured due to the split structure of the rim.

Further, according to the present invention, as compared to a casting method according to the related art in which environmental pollution is severe, the split rim-type assembly pulley may be manufactured to be eco-friendly and contribute to work efficiency and health of a worker by improving a work environment.

Although the present invention has been described with reference to the accompanying drawings, various modifications may be made without departing from the technical spirit of the present invention. Thus, the scope of the present invention should not be limited to the embodiment but should be determined by the appended claims and those equivalent to the appended claims.

### INDUSTRIAL APPLICABILITY

A split rim-type assembly pulley and a method of manufacturing the same, in which the split rim-type assembly pulley may be manufactured in the form of assembly through press processing instead of performing a casting process or a forging process and thus easily manufactured in various specifications and forms, in particular, a large pulley may be easily manufactured due to a split structure of a rim, and as compared to a casting method according to the related art in which environmental pollution is severe, the split rim-type assembly pulley may be manufactured to be eco-friendly and contribute to work efficiency and health of a worker by improving a work environment, are provided.

1. A split rim-type assembly pulley comprising:
a hub coupled to a shaft;
a plurality of arms each having one end coupled to the hub and radially arranged around the hub;
a plurality of split rims which are members having an arc shape and are arranged in a circular shape to form a unit rim, in which the plurality of unit rims are stacked in the split rims, and which are coupled to the other ends of the arms to form a rim fixed to form concentricity in the hub; and
a plurality of fastening members fastened to the plurality of split rims to maintain a state in which the split rims constitute the rim.

2. The split rim-type assembly pulley of claim 1, wherein, in the hub, an arm coupling portion protrudes along an outer circumferential surface thereof for bolting fastening with the arm, and a plurality of fastening holes are spaced apart from each other in the arm coupling portion.

3. The split rim-type assembly pulley of claim 2, wherein in the hub, the plurality of arm coupling portions are provided side by side, so that the plurality of arms are coupled to be arranged in a longitudinal direction of the shaft.

4. The split rim-type assembly pulley of claim 1, wherein, in the arm, a reinforcement wing portion is provided by bending one side or both sides thereof.

5. The split rim-type assembly pulley of claim 3, wherein, in the arm, a reinforcement wing portion is provided by bending one side or both sides thereof, and when the plurality of arms are arranged, the reinforcement wing portions are arranged to face each other.

6. The split rim-type assembly pulley of claim 1, wherein, when the split rim forms the unit rim, a bent portion is formed by bending an outer circumferential surface of the unit rim by press processing, and when the unit rim is stacked to be symmetrical in a left-right direction to form the rim, a groove which is open to the outside and on which a V-belt is seated is provided between the bent portions.

7. The split rim-type assembly pulley of claim 6, further comprising:
a first spacer configured to allow a fastening bolt of the fastening member to pass therethrough such that the first spacer is located between the split rims located on both sides of the groove to maintain a width of the groove in correspondence with specifications of the V-belt; and
a second spacer configured to allow a fastening bolt of the fastening member to pass therethrough such that the second spacer is located between the split rims located between the pair of grooves to be disposed alternately with the first spacer on the fastening bolt.

8. The split rim-type assembly pulley of claim 1, wherein the split rim maintains a state in which the rim is formed by the fastening member in a state in which boundary portions with other split rims are arranged to not to be aligned from each other in each of the neighboring unit rims.

9. The split rim-type assembly pulley of claim 1, wherein the fastening member includes:
a fastening bolt which passes through the plurality of stacked split rims and of which an end protrudes; and
a fastening nut fastened to the end of the fastening bolt to prevent separation of the stacked split rims.

10. The split rim-type assembly pulley of claim 9, wherein the arm is fixed to the split rim by the fastening member as the fastening bolt passes through the other end of the arm.

11. The split rim-type assembly pulley of claim 10, further comprising a third spacer stacked and inserted together with the other end of the arm between the split rims located on both sides of a groove, on which a V-belt is seated, such that the fastening bolt passes therethrough, to maintain a width of the groove in correspondence to specifications of the V-belt.

12. A method of manufacturing the split rim-type assembly pulley of claim 1, wherein a plurality of split rims which are members having an arc shape are arranged in a circular shape to form a unit rim, a shape of a rim formed by stacking the plurality of unit rims is maintained by fastening a fastening member, an end of each of a plurality of arms radially coupled around a hub is coupled to the rim, so that the rim is concentrically fixed to the hub.

13. The method of claim 12, wherein the end of each of the arms is fixed to the rim by the fastening member fastened to maintain the shape of the rim.
